(19) United States
(12) Patent Application Publication
(10) Pub. No.: US 2007/0273746 A1
(43) Pub. Date: Nov. 29, 2007

(54) MULTIPLE MEDIA, MULTIPLE PRINT HEAD METHOD AND APPARATUS

(75) Inventors: Timothy S. Holzschuh, Littleton, CO (US); Dean O. Miller, Littleton, CO (US); Raul G. Palacios, Littleton, CO (US); Ron D. Phillips, Golden, CO (US)

Correspondence Address: SHERIDAN ROSS PC, 1560 BROADWAY, SUITE 1200, DENVER, CO, 80202, US

(73) Assignee: COGNITIVE SOLUTIONS, INC., Golden, CO (US)

(21) Appl. No.: 11/753,743

(22) Filed: May 25, 2007

Related U.S. Application Data
(60) Provisional application No. 60/803,332, filed on May 26, 2006.

(51) Int. Cl. G01D 15/10

(52) U.S. Cl. 347/220

(57) ABSTRACT

A printer having multiple media supplies and multiple print heads and method for using the same is provided. More particularly, each print head included in the printer may be associated with one of the media supplies. Printer control electronics, a power supply, and interconnections to a computer or other device can be shared by the multiple print heads. Each print head may be associated with a platen, or a platen may be shared among multiple print heads. Where a platen is shared by multiple print heads, the platen may be rotated in a first direction to draw media past a first one of the print heads and in a second direction to draw media past a second one of the print heads. Moreover, a print head that is not in use can be moved so that it is not in contact with a moving platen.

### CROSS-REFERENCE TO RELATED APPLICATIONS

This application claims the benefit of U.S. Provisional Application No. 60/803,332, filed May 26, 2006, the entire disclosure of which is hereby incorporated herein by reference.

### FIELD

The present invention relates to printer devices.

### BACKGROUND

Printers are commonly used to produce hard copy output in a variety of situations. One type of printer is the thermal printer. A thermal printer may operate as a direct thermal printer, in which images are formed on a specially treated paper or other media by applying heat directly to the surface of the media. Another type of thermal printer is the thermal transfer printer, in which an image is formed by applying heat to a ribbon, which causes the transfer of wax and/or resin from the ribbon to the media. In addition, thermal printers that are capable of operating as direct thermal or thermal transfer devices are available.

Corresponding to the two main types of thermal printer technologies, there are two main categories of thermal printer media; media adapted for use in direct thermal printers and media adapted for use in thermal transfer printers. Media adapted for use in a direct thermal printer is specially treated. In particular, media for direct thermal printers typically has a coating that changes color as heat is applied. Accordingly, no ribbon is required. However, the media has a relatively short shelf life. In addition, the image produced by the print process is limited to the capabilities of the media. Also, the media is sensitive to degradation from exposure to heat, the outdoors, or other harsh environments. Media that is adapted for use in connection with thermal transfer printers must receive ink that has been released from a ribbon using heat. Accordingly, such media is generally adapted to have good ink receptivity. However, the media itself is not heat sensitive. As a result, the media has a relatively long shelf life. In addition, the color of the output is not as limited as for direct thermal printers.

Media comprises a substrate on which the image is formed. Media for thermal printers, whether direct thermal or thermal transfer, may comprise a substrate made from a variety of materials, such as paper, films, or foils. In addition, the substrate of the media may be either unsupported or pressure sensitive. Unsupported substrate refers to any substrate that does not have a backing. A pressure sensitive substrate typically comprises a label adhered to a backing.

Examples of applications in which thermal printers have become prevalent include the ski industry, which commonly uses thermal printers to produce tickets at the point of sale on a durable label media. Another example is automotive service labeling, in which reminder labels for oil changes or other periodic maintenance procedures may be printed out on demand and placed in a customer's windshield. Examples of general business applications that use thermal printers include archive data labeling, asset inventory tracking, retail pricing, and media record tracking. Another example is the health care industry which uses thermal printer technology in connection with laboratory sample identification, patient identification, pharmacy labeling, x-ray tracking, etc. In addition to including textual information or graphics, labels often include machine-readable barcodes.

Depending on the use of the output being produced by the thermal printer, output of different sizes may be desirable. Most thermal printers use rolls of media. Accordingly, media comprising an unsupported substrate can be cut to an appropriate length after printing, either manually or automatically. Therefore, a thermal printer loaded with media having an unsupported substrate can produce output on pieces of media having different lengths without requiring that the media be changed. However, producing an output on media of a different width requires that the media loaded into the printer be changed, or that a different printer with media of the desired width already loaded be used. Similarly, in connection with media comprising a supported substrate (e.g., adhesive labels), the substrate is typically divided into segments of one size. Furthermore, cutting supported media following printing is a difficult, and particularly when performed automatically, unreliable process. As a result, where output on media having a supported substrate is desired in different sizes, including in different lengths, different media must be loaded into the thermal printer or a different thermal printer with the desired media already loaded must be used.

In order to provide multiple media types, and as an alternative to requiring manual loading of media to change the media being used, printers that incorporate elaborate media changing or tray-lifting mechanisms have been developed. More particularly, these printers have provided automated means to change the media that is supplied to the print head or mechanism. Although such printers have had success in certain applications, they are typically less reliable, more expensive and more complicated than printers that do not include automated means for changing the media supply.

In addition to difficulties in accommodating output of different sizes, different media having different characteristics may be desired for different applications. Accordingly, many users have needed to have a number of thermal printer devices in order to accommodate different media output needs.

### SUMMARY

The present invention is directed to solving these and other problems and disadvantages of the prior art. In particular, embodiments of the present invention provide thermal printers having multiple media supplies and multiple print heads. More particularly, embodiments of the present invention provide thermal printers having multiple media supplies and a print head for each of the media supplies. In addition, embodiments of the present invention provide thermal printers having a single or common set of communication and control electronics for the multiple media supplies and multiple print heads.

A thermal printer in accordance with embodiments of the present invention may be configured such that the multiple media supplies and multiple print heads are arrayed horizontally or vertically within a common enclosure. Other embodiments of the present invention may include a reversible platen in which a first print head associated with a first media supply is positioned on one side of the platen, and in which a second print head associated with a second media supply is positioned on another side of the platen, generally opposite the first print head. The platen is operated in a first direction in order to provide output using the first print head and first media supply, and the platen is operated in a second direction in order to provide output using the second print head and the second media supply.

In accordance with still other embodiments of the present invention, methods for providing output from a thermal printer having a plurality of media supplies and a plurality of print heads are provided. The methods may include receiving data at the printer, control electronics comprising image data and/or information, or input comprising a command related to the media supply and/or print head that is to be used in connection with producing output comprising the image. The control electronics then may operate to energize the appropriate print head and supply the appropriate media to that print head to produce the requested output.

Additional features and advantages of embodiments of the present invention will become more readily apparent from the following discussion, particularly when taken together with the accompanying drawings.

### BRIEF DESCRIPTION OF THE DRAWINGS

FIG. 1 is a block diagram depicting components of a multiple media, multiple print head printer in accordance with embodiments of the present invention;

FIG. 2 is a schematic depiction of a multiple media, multiple print head printer in accordance with embodiments of the present invention;

FIG. 3 is a schematic depiction of a multiple media, multiple print head printer in accordance with other embodiments of the present invention;

FIG. 4 is a schematic depiction of a print head position control mechanism in accordance with embodiments of the present invention;

FIG. 5 is a schematic depiction of a portion of a multiple media, multiple print head printer in accordance with embodiments of the present invention;

FIG. 6 is a schematic depiction of a portion of a multiple media, multiple print head printer in accordance with other embodiments of the present invention; and

FIG. 7 is a flow chart depicting aspects of a method for providing output in connection with a multiple media, multiple print head printer.

### DETAILED DESCRIPTION

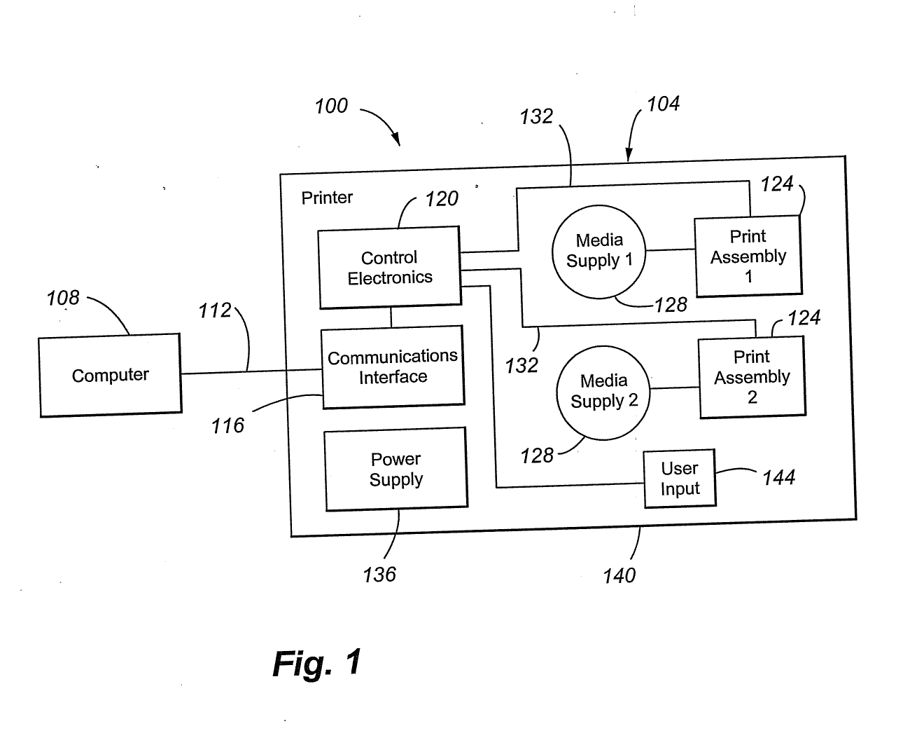

In FIG. 1, a system 100 comprising a printer 104 in accordance with embodiments of the present invention, interconnected to a computer 108, is depicted. In general, the printer 104 is a multiple media supply, multiple print head device, as described in detail herein. The computer 108 may be any general purpose or specialized computer including a desktop or laptop computer, personal digital assistant (PDA), cash register, server, workstation or any other device capable of providing a file or collection of data comprising image information to the printer 104 across a communication link 112. In accordance with embodiments of the present invention, the communication link 112 is not limited to any particular technology or protocol. Furthermore, the communication link 112 may be a wireline or wireless link. Examples of a wired communication link 112 include Universal Serial Bus (USB), IEEE 1394, RS-232, Ethernet, or other serial or parallel direct or shared connection. Examples of wireless communication links 112 include connections established in accordance with one of the various IEEE 802.11 standards, IrDA, Bluetooth or other wireless technologies or protocols. As can be appreciated by one of skill in the art, a printer 104 does not need to be interconnected to a computer 108. Instead, a printer 104 may operate as a stand-alone printer in accordance with programming or instructions running on a printer operating system.

The printer 104 generally includes a communications interface 116 that interconnects to the communication link 112. The communications interface 116 is in turn interconnected to control electronics 120. The control electronics 120 may comprise a processor capable of executing instructions stored in memory provided as part of the control electronics 120 and/or provided from the communications interface 116.

The printer 104 additionally includes a plurality of print assemblies 124. Each print assembly 124 is associated with a media supply 128. Although only two print assemblies 124 and associated media supplies 128 are shown in FIG. 1, it should be appreciated that the number of print assemblies 124 and media supplies 128 that may be included in a printer 104 in accordance with embodiments of the present invention is not limited to any particular number.

The control electronics 120 are interconnected to each of the print assemblies 124. As illustrated in FIG. 1, these connections can be completed by dedicated signal lines 132. Alternatively or in addition, communications between the control electronics 120 and the print assemblies 124 can be completed across a shared bus. As shown, embodiments of the present invention feature one set of control electronics 120 that operate to control all of the print assemblies 124 included in the printer. The printer 104 may additionally include a power supply 136. The power supply 136 may comprise a connection to AC line power and/or a battery. In addition, the power supply 136 may include voltage transformers, rectifying circuits, voltage converters, or other circuitry needed to support the various power requirements of the included components. The printer 104 may also be associated with an enclosure or chassis 140 to structurally interconnect or house the components of the printer 104. A user input 144 may also be provided as part of the printer 104 in order to receive control inputs from a user. Control inputs entered through a user input 144 may comprise, for example, a command to turn the printer on or off. Another example of a control input that can be entered through a user input is data for inclusion in a label or other output to be printed that is entered through a user input 144 comprising a keyboard directly connected to or included in the printer 104. As can be appreciated by one of skill in the art, user input or other data can also be provided via a computer 108 and communication link 1 12 during operation or use of the printer or during manufacture of the printer 104.

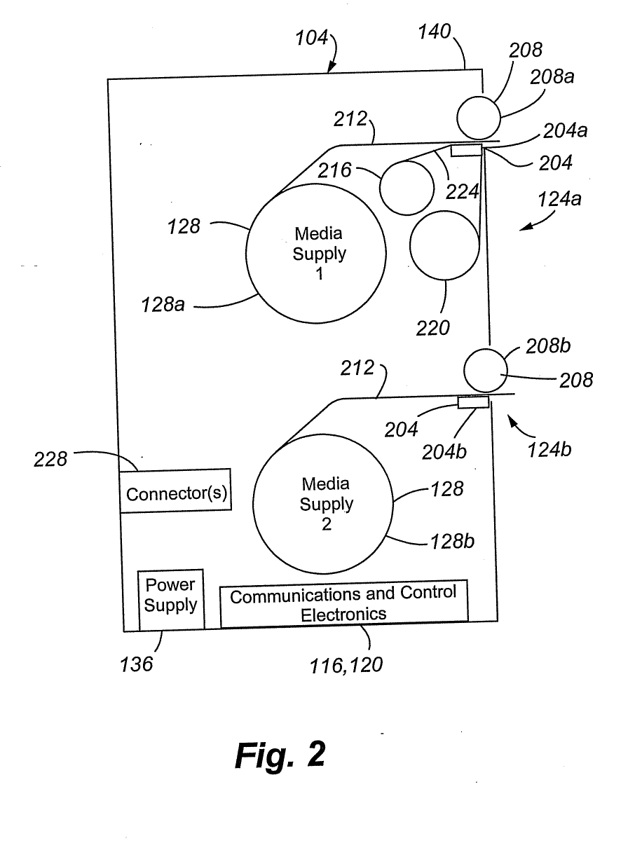

In FIG. 2, a printer 104 configuration in accordance with certain embodiments of the present invention is depicted. In the embodiment illustrated in FIG. 2, a first print assembly 124a is shown above a second print assembly 124b. Accordingly, FIG. 2 illustrates an example of a printer 104 in which the print assemblies 124 are arranged vertically with respect to one another.

The first print assembly 124a generally includes a print head 204a and a platen 208a. As can be appreciated by one of skill in the art, the print head 204a and/or the platen 208a may be biased towards one another to hold media 212 provided by a first media supply 128a therebetween.

As can be appreciated by one of skill in the art, the print head 204 may comprise a thermal print head having a number of elements that can be energized such that heat is produced at a selected point along the length of the print head 204. By controlling the amount of time that the element remains energized, a dot or a line of a selected length can be created on the media 212 passing over the print head 204. The media 212 is passed or drawn over the print head 204 by the platen 208, which is driven by a motor (not shown) under the control of the control electronics 120.

The first print assembly 124a is shown as a thermal transfer type print assembly. Accordingly, a ribbon supply reel 216 and a ribbon takeup reel 220 are illustrated. In general, the ribbon supply reel 216 provides a ribbon 224 at the same rate that the media 212 is drawn across the print head 204. The print head 204 then applies heat to the ribbon 224 to transfer the image to the media 212. The used ribbon 224 is then collected by the ribbon takeup reel 220. The second print assembly 124b is depicted as a direct thermal assembly. Accordingly, no separate ribbon supply assembly is shown in association with the second print assembly 1246.

A common set of communications interface 116 and control electronics 120 are used to control operation of the first 124a and second 124b print assemblies. In addition, a single power supply 136 and a single connector or a set of connectors 228 are provided with the printer 104. Accordingly, multiple media 212 capabilities are provided in connection with multiple print assemblies 124, while requiring only one set of communications and control electronics 116, 120, one power supply 136, and one connector or set of connectors 228. These components may be housed within a common housing 140.

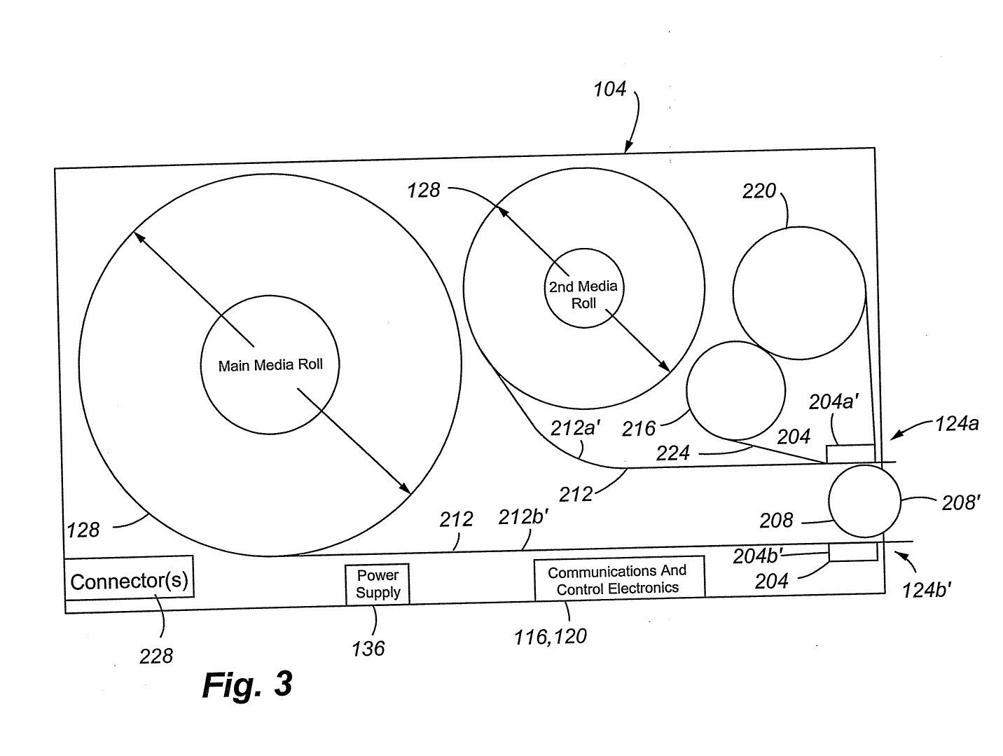

FIG. 3 is a schematic depiction of a printer 104 in accordance with other embodiments of the present invention. In particular, a first print assembly 124a′ and a second print assembly 124b′ that share a common platen 208 are illustrated. When the platen is rotated in a first direction (clockwise in FIG. 3), media 212a′ is drawn across the print head 204a′ associated with the first print assembly 124a′. When the platen 208′ is operated in the reverse direction (counterclockwise in FIG. 3), media 212b′ is drawn across the print head 204b′ associated with the second print assembly 124b′.

As with other embodiments, a printer 104 having a reversible common platen 208 provides multiple media 212 capabilities in connection with multiple print heads 204, while requiring only one set of communications and control electronics 116, 120, one power supply 136, and one connector or set of connector(s) 228.

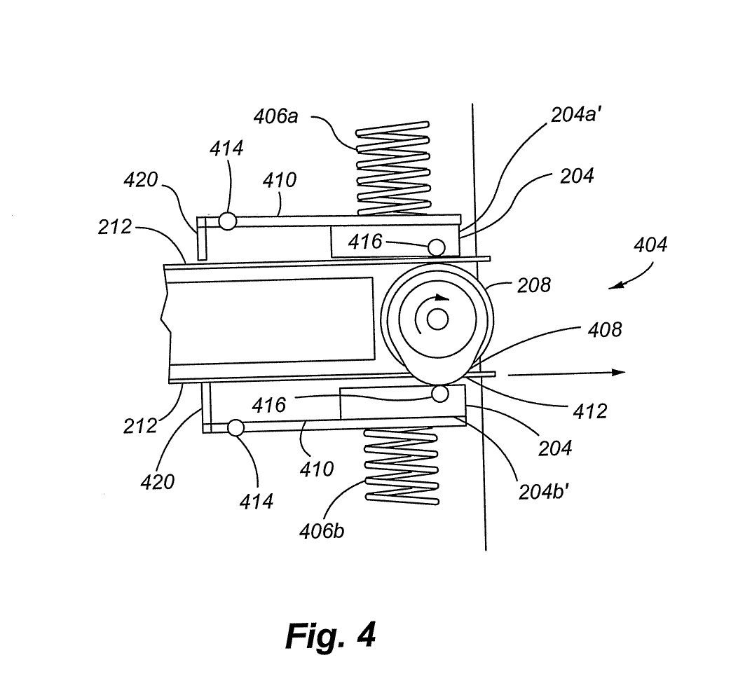

FIG. 4 illustrates a print head control mechanism 404 in accordance with embodiments of the present invention. As can be appreciated by one of skill in the art, a print head 204 experiences wear as a result of passing media 212, and to a lesser extent print ribbon 224, across the surface of the print head 204. Furthermore, a print head 204 and associated platen 208 are typically biased towards one another. For example, a spring 406a and 406b is provided for each print head 204a′ and 204b′ to bias the respective print head 204 towards the platen 208. In order to prevent wear that might be caused to a print head 204 as a result of rotating the reversible platen 208′ of the embodiment of FIG. 3 while the companion print head 204 is being used to produce an image, the print head position control mechanism 404 can be operated to move the print head 204 (e.g. print head 204b′ in FIG. 4) that is idle away from the platen 208.

In accordance with embodiments of the present invention, the print head control mechanism 404 may comprise a cam 408 with a lobe 412 that acts on a print head lug 416 to pivot an associated print head carrier 410 about a pivot point 414 and to move the print head 204 away from the surface of the platen 208. In accordance with further embodiments of the present invention, the print head control mechanism 404 may comprise a pair of cams 408 that each includes a lobe 412 that acts on a corresponding print head lug 416. The cams 408 may rotate about the same axis as the platen 208. Furthermore, the cams 408 may be rotated by a drive mechanism that places or orients the lobes 412 such that they act against the lugs 412 of the inactive print head 204 in response to the rotation of the drive platen 208 in a particular direction. For example, as shown in FIG. 4, when the drive platen 208 is rotated in a clockwise direction, the cams 408 are also rotated in a clockwise direction until the lobes 412 are acting on the lugs 416 of the second print head 204b′, at which point an internal stop is reached to prevent further rotation of the cams 408. If the drive platen 208 is then rotated in a counter-clockwise direction, the cams 408 will rotate in counter-clockwise direction until the lugs 412 are acting on the lugs 416 of the first print head 204a′, at which point another internal stop is reached to prevent further rotation of the cams 408. Of course, alternate means for driving the cams 408, such as a dedicated motor, are also possible.

A holding mechanism 420 for holding the media 212 associated with a print head 204 that is not being used in position while other media 212 is being drawn across its associated print head 204 to produce an output may also be provided. The holding mechanism 420 may comprise a passive arrangement, such as an elastic wiper or other member or assembly that maintains the position of non-selected media 212 using friction. Alternatively, or in addition, a holding mechanism 420 may comprise an active mechanism that acts on non-selected print media 212, and that releases that media 212 once it is selected. For example, an active holding mechanism 420 may be combined with a print head control mechanism 404 such that when a print head 204 is moved away from the platen 208, the holding mechanism 420 for the media 212 associated with the lifted or moved print head 204 is activated. For example, a holding mechanism 420 may be connected to a print head carrier 410 such that it engages the media 212 when an associated print head 204 is moved away from the platen 208. Particular examples of a holding mechanism include clamps, friction wheels, friction surfaces and wipers.

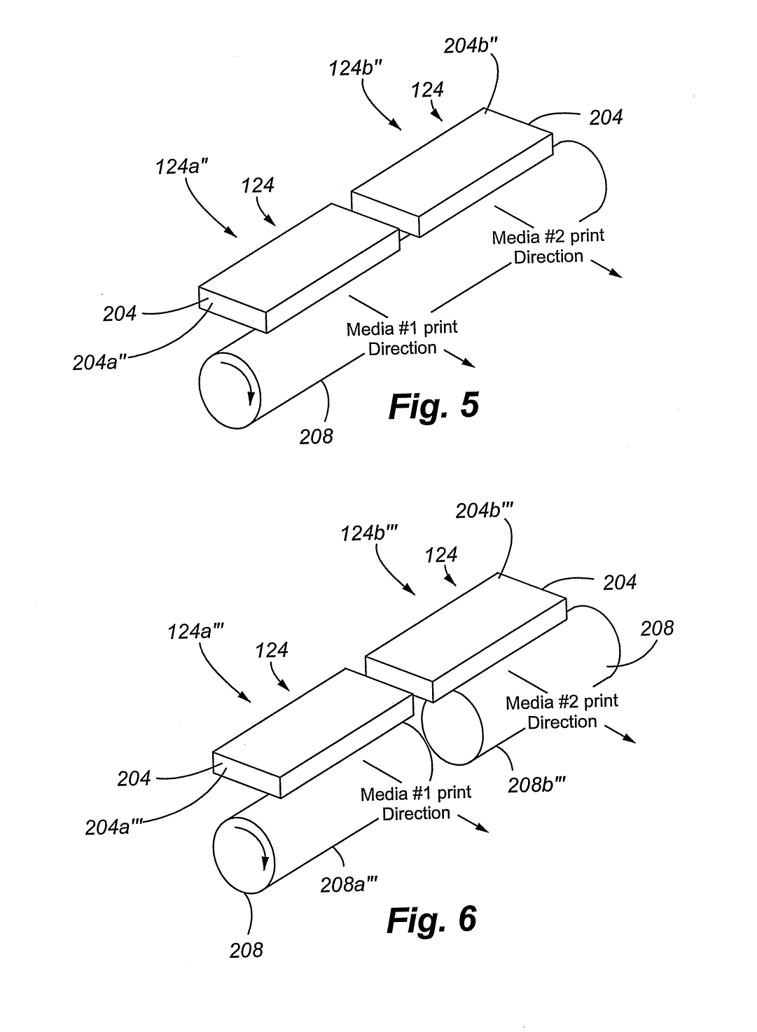

FIG. 5 is a schematic depiction of an arrangement of print assemblies 124 that may be provided as part of a printer 104 in accordance with embodiments of the present invention. More particularly, a configuration in which multiple print heads 204 are in a side-by-side or horizontal configuration with respect to one another is depicted. Furthermore, although each print assembly 124 includes a print head 204, the print assemblies 124 share a common platen 208. According to such embodiments, while a first print assembly 124a″ is being used to produce output on associated media, the print head 204a″ of the first print assembly 124a″ will be biased towards the drive platen 208 such that the print head 204a″ presses the media against the surface of the drive platen 208. The rotation of the drive platen 208 will draw the media across the surface of the print head 204a″. Meanwhile, the second print assembly 124b″ will typically (although not necessarily) be inactive. Accordingly, the print head 204b″ of the second print assembly 124b″ may be moved or unbiased with respect to the surface of the drive platen 208, such that associated media is not drawn across the surface of the second print head 204b″. In order to produce output using the second print assembly 124b″ the second print head 204b″ is biased such that the associated media is pressed against the drive platen 208 by the second print head 204b″, and drawn across the surface of the second print head 204b″. While the second print assembly 124b″ is operational, the print head 204a″ of the first print assembly 124a″ is typically (although not necessarily) moved or unbiased with respect to the surface of the drive platen 208.

FIG. 6 is a schematic depiction of an arrangement of print assemblies 124 in connection with a printer 104 in accordance with other embodiments of the present invention. In general, the embodiment illustrated in FIG. 6 is similar to the embodiment illustrated in FIG. 5, except that separate drive platens 208a′″ and 208b′″ are provided for the separate print assemblies 124a′″ and 124b′″. According to such an arrangement, a print head 204 may remain biased against a corresponding drive platen 208 in order to hold associated media therebetween, even when the print head 204 is not being used in connection with the production of output. Furthermore, because the print heads 204 can remain biased against an associated drive platen 208 even when output is not being produced by the print head 204, mechanisms for moving the print head 204 away from the surface of the drive platen 208 to reduce wear on the print head 204 can be omitted. In addition, where the print head 204 is not moved away from the surface of the drive platen 208 when the associated print assembly 124 is inactive, the print head 204 can perform a holding or clamping function with respect to associated media. Furthermore, such an arrangement retains the advantages of providing multiple media capabilities that are provided with multiple print assemblies 124, while requiring only one set of communications 116 and control electronics 120, one power supply 136, and one connector or set of connectors 228, that may all be housed within a common housing 140.

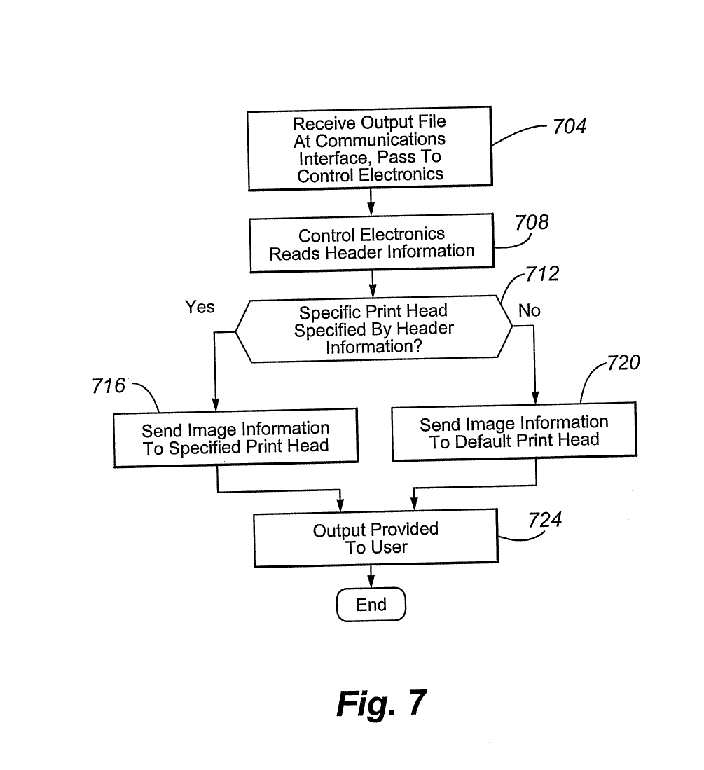

FIG. 7 is a flow chart illustrating aspects of a method for providing output from a multiple media multiple print head printer in accordance with embodiments of the present invention. Initially, at step 704, an output file comprising header data or information and image data or information is received from the communication link 112 at the communications interface 116 of the printer 104. The output file is passed to the control electronics 120 by the communications interface 116. Alternatively, this output file could be generated internally by the control electronics 120 of the printer 104, with or without user input. The control electronics 120 then read the header information included in the output file (step 708).

At step 712, a determination is made as to whether the output file specifies or identifies a particular print head 204 included in the printer 104 that is to be used to produce the output specified by the image data. The specification of a particular print head 204 may comprise an explicit identification of the print head 204 to be used to produce the desired output. The print head 204 can also be specified inferentially. For example, the output file may specify that a particular media type be used to produce the output, and the print head 204 associated with the media supply 128 in which the specified media type is loaded is accordingly selected.

If it is determined that a particular print head 204 has been identified by information in the output file, the image information from the output file is sent to the specified print head 204 (step 716). Alternatively, if no print head 204 is specifically identified, the image information may be sent to a default print head 204 (step 720). As used herein, a default print head 204 may comprise a print head that has been pre-selected for use where image information does not specify any other print head. A default print head may also comprise a print head 204 that is available and that has media loaded into the associated media supply 128. After sending the image information to one of the print heads 204 included in the printer 104, the output is provided to the user (step 724), and the process may end.

The foregoing discussion of the invention has been presented for purposes of illustration and description. Furthermore, the description is not intended to limit the invention to the form disclosed herein. Consequently, variations and modifications commensurate with the above teachings, within the skill and knowledge of the relevant art, are within the scope of the present invention. The embodiments described hereinabove are further intended to explain the best mode presently known of practicing the invention and to enable others skilled in the art to utilize the invention in such, or in other embodiments, and with the various modifications required by their particular application or use of the invention. It is intended that the appended claims be construed to include alternative embodiments to the extent permitted by the prior art.

What is claimed is:

1. A printer, comprising:
a chassis;
a power supply interconnected to the chassis;
a control circuit interconnected to the chassis;
a communication interface interconnected to the control circuit;
a first print head interconnected to the control circuit;
a first media supply assembly operable to supply media to the first print head;
a second print head interconnected to the control circuit;
a second media supply assembly operable to supply media to the second print head; and
a platen operable to draw media from the first media supply assembly across the first print head.

2. The printer of claim 1, wherein:
in a first mode of operation the platen rotates in a first direction, wherein media is supplied from the first media supply assembly to the first print head, and
in a second mode of operation the platen rotates in a second direction, wherein media is supplied from the second media supply assembly to the second print head.

3. The printer of claim 2, further comprising:
a print head position control mechanism, wherein in the first mode of operation the print head control mechanism moves the second print head away from the platen, and wherein in the second mode of operation the print head control mechanism moves the first print head away from the platen.

4. The printer of claim 3, further comprising:
a first holding mechanism, wherein in the second mode of operation the first holding mechanism is engaged to hold media from the first media supply stationary with respect to the first print head; and
a second holding mechanism, wherein in the first mode of operation the second holding mechanism is engaged to hold media from the second media supply stationary with respect to the second print head.

5. The printer of claim 2, wherein the print head position control mechanism includes a cam that operates on a lug associated with the second print head in the first mode of operation and that operates on a lug associated with the first print head in the second mode of operation, and wherein the lug moves in response to rotation of the platen.

6. The printer of claim 5, further comprising:
a first holding mechanism, wherein media associated with the first media supply assembly is held stationary in the second mode of operation;
a second holding mechanism, wherein media associated with the second media supply is held stationary in the first mode of operation.

7. The printer of claim 2, further comprising:
a first holding mechanism, wherein media associated with the first media supply assembly is held stationary in the second mode of operation;
a second holding mechanism, wherein media associated with the second media supply is held stationary in the first mode of operation.

8. The printer of claim 2, wherein the first and second print heads are located on opposite sides of the platen.

9. The printer of claim 1, wherein the platen operable to draw media from the first media supply assembly across the first print head is a first platen, the printer further comprising:
a second platen operable to draw media from the second media supply assembly across the second print head, wherein the first print head and first platen are provided as part of a first print assembly, wherein the second print head and the second platen are provided as part of a second print assembly, and wherein the first print assembly is located above the second print assembly.

10. The printer of claim 1, further comprising:
a ribbon supply mechanism associated with the first print head.

11. A method for providing output from a thermal printer, comprising:
in connection with a first print operation:
receiving a first set of data at a printer controller included in a thermal printer, wherein the first set of data includes header data and image data, and wherein the printer includes a plurality of print heads;
selecting a first print head from the plurality of print heads for use in producing a first output from the received image data included in the first set of data;
energizing the first print head;
controlling a first media feed mechanism to provide first media to the first print head, wherein the controlling includes rotating a first platen, and wherein first media is provided to the energized first print head to produce the first output;
in connection with a second print operation:
receiving a second set of data at the printer controller, wherein the second set of data includes header data and image data;
selecting a second print head from the plurality of print heads for use in producing a second output from the received image data included in the second set of data;
energizing the second print head; and
controlling one of the first media feed mechanism and a second media feed mechanism to provide second media to the second print head, wherein said controlling includes rotating one of the first platen and a second platen, and wherein second media is provided to said energized second print head to produce a second output.

12. The method of claim 11, wherein selecting a first print head from a plurality of print heads includes:
obtaining from the header data included in the first set of data information comprising an identification of a first print head included in the plurality of print heads.

13. The method of claim 12, wherein selecting a second print head from a plurality of print heads includes:
obtaining from the header data included in the second set of data information comprising an identification of a second print head included in the plurality of print heads.

14. The method of claim 12, wherein the data comprising an identification of a first print head included in the plurality of print heads comprises data specifying a need for output that can be provided in connection with the first print head and not the second print head.

15. The method of claim 11, wherein controlling a first media feed mechanism to provide first media to the first print head includes rotating a first platen in a first direction, and
wherein controlling one of the first media feed mechanism and a second media feed mechanism includes rotating the first platen in a second direction.

16. The method of claim 15, further comprising:
in connection with the first print operation, moving the second print head away from the first platen; and
in connection with the second print operation, moving the first print head away from the first platen.

17. The method of claim 11, wherein controlling a first media feed mechanism to provide first media to the first print head includes rotating a first platen, and
wherein controlling one of the first media feed mechanism and a second media feed mechanism includes rotating a second platen.

18. The method of claim 1, wherein controlling a first media feed mechanism to provide first media to the first print head includes rotating a first platen, and
wherein controlling one of the first media feed mechanism and a second media feed mechanism includes rotating the first platen.

19. A thermal printer device, comprising:
means for enclosing printer components;
a plurality of means for supplying media interconnected to the means for enclosing;
a plurality of means for applying heat to media in order to create an image interconnected to the means for enclosing;
means for drawing selected media over a selected means for applying heat interconnected to the means for enclosing, wherein the means for drawing selected media over a selected means for applying heat comprises a platen that is rotated in a first direction for drawing selected media over a first one of the plurality of means for applying heat and is operated in a second direction for drawing selected media over a second one of the plurality of means for applying heat.

20. The thermal printer device of claim 19, further comprising:
control means, wherein a selected one of the plurality of means for applying heat is operated by the control means in response to a command to produce printed output
